(19) United States
(12) Patent Application Publication
(10) Pub. No.: US 2018/0339628 A1
(43) Pub. Date: Nov. 29, 2018

(54) VEHICLE SEAT

(71) Applicant: TOYOTA BOSHOKU KABUSHIKI KAISHA, Aichi-ken (JP)

(72) Inventor: Koji KIMURA, Aichi-ken (JP)

(73) Assignee: TOYOTA BOSHOKU KABUSHIKI KAISHA, Aichi-ken (JP)

(21) Appl. No.: 15/970,140

(22) Filed: May 3, 2018

(30) Foreign Application Priority Data
May 25, 2017 (JP) 2017-103845

(51) Int. Cl. B60N 2/90; B60N 2/68; B60N 2/30

(52) U.S. Cl. CPC B60N 2/995; B60N 2/06; B60N 2/3047; B60N 2/686

(57) ABSTRACT

A vehicle seat includes a seat cushion on which an occupant sits and an ottoman provided on the seat cushion. The seat cushion includes side frames provided at a distance from each other in a direction of width of a seat and an ottoman support portion provided in the side frames. The ottoman support portion includes an upper member, a lower member arranged below the upper member, and a mount connected to the lower member. The upper member is connected to the side frames. The lower member is connected to the side frames. The lower member includes side plates located in the direction of width of the seat. At least one of the side plates is connected to the upper member.

This nonprovisional application is based on Japanese Patent Application No. 2017-103845 filed with the Japan Patent Office on May 25, 2017, the entire contents of which are hereby incorporated by reference.

### BACKGROUND

### Field

The present disclosure relates to a vehicle seat and particularly to a vehicle seat with an ottoman.

### Description of the Background Art

Various vehicle seats have conventionally been proposed (see Japanese Patent Laying-Open No. 2010-260537) and for example, various vehicle seats with ottoman have also been proposed.

In general, the vehicle seat with ottoman includes a seat back, a seat cushion, and an ottoman. The ottoman is provided on a side of a front end portion of the seat cushion. The ottoman is provided as being movable between a storage position below the front end portion of the seat cushion and a developed position in front of the seat cushion.

For example, a vehicle seat described in Japanese Patent Laying-Open No. 2013-112128 includes a seat cushion which can be tipped up and an ottoman provided at a front end portion of the seat cushion.

### SUMMARY

In a vehicle seat with an ottoman, a seat cushion includes a cushion frame and a cushion pad provided on the cushion frame. The cushion frame includes a left side frame and a right side frame arranged at a distance from each other in a lateral direction and an ottoman support portion which supports the ottoman.

The ottoman support portion includes an upper member and a lower member arranged between the side frames and a mount connected to the lower member and provided with the ottoman. The upper member and the lower member are arranged at a distance from each other in a vertical direction.

The upper member has opposing ends in a direction of width of a seat connected to respective side frames. The lower member is arranged below the upper member at a distance therefrom and the lower member has opposing ends in the direction of width of the seat connected to respective side frames. The mount provided with the ottoman is connected to the lower member.

A load imposed by a self weight of the ottoman is applied to the mount. Since the mount is connected to the lower member, the lower member and the side frames bear the self weight of the ottoman. Consequently, the lower member may significantly be deformed.

The present disclosure was made in view of the problem as described above and an object thereof is to provide a vehicle seat in which deformation of an ottoman support member is suppressed.

A vehicle seat according to the present disclosure includes a seat cushion which supports an occupant and an ottoman provided on the seat cushion. The seat cushion includes a first side frame and a second side frame provided at a distance from each other in a direction of width of the seat and an ottoman support portion provided in the first side frame and the second side frame. The ottoman support portion includes an upper member, a lower member arranged below the upper member, and a mount connected to the lower member. The upper member is connected to the first side frame and the second side frame. The lower member is connected to the first side frame and the second side frame. The lower member includes a first end portion and a second end portion located in the direction of width of the seat and at least one of the first end portion and the second end portion is connected to the upper member.

According to the construction above, the lower member is supported by the first and second side frames and the upper member. Therefore, deformation of the lower member is suppressed.

The foregoing and other objects, features, aspects and advantages of the present disclosure will become more apparent from the following detailed description when taken in conjunction with the accompanying drawings.

### BRIEF DESCRIPTION OF THE DRAWINGS

FIG. 1 is a side view schematically showing a vehicle seat 1.

FIG. 2 is a side view showing vehicle seat 1 while a seat cushion 3 is located at a tipped-up position.

FIG. 3 and FIG. 4 are perspective views showing a cushion frame 7.

FIG. 5 is an exploded perspective view showing cushion frame 7.

FIG. 6 is a perspective view of an upper panel 22 from below.

FIG. 7 is a perspective view of a lower panel 23 from below.

FIG. 8 is a cross-sectional view along the line VIII-VIII shown in FIG. 3.

FIG. 9 is a cross-sectional view along the line IX-IX shown in FIG. 3.

FIG. 10 is a cross-sectional view showing a side plate 41 and a feature around the same.

FIG. 11 is a cross-sectional view showing a side plate 42 and a feature around the same.

FIG. 12 is a cross-sectional view showing upper panel 22, lower panel 23, and side frames 20 and 21 in a vehicle seat according to a second embodiment.

FIG. 13 is a cross-sectional view showing a side plate 51 of lower panel 23 and a feature around the same.

FIG. 14 is a cross-sectional view showing a side plate 52 of lower panel 23 and a feature around the same.

### DESCRIPTION OF THE PREFERRED EMBODIMENTS

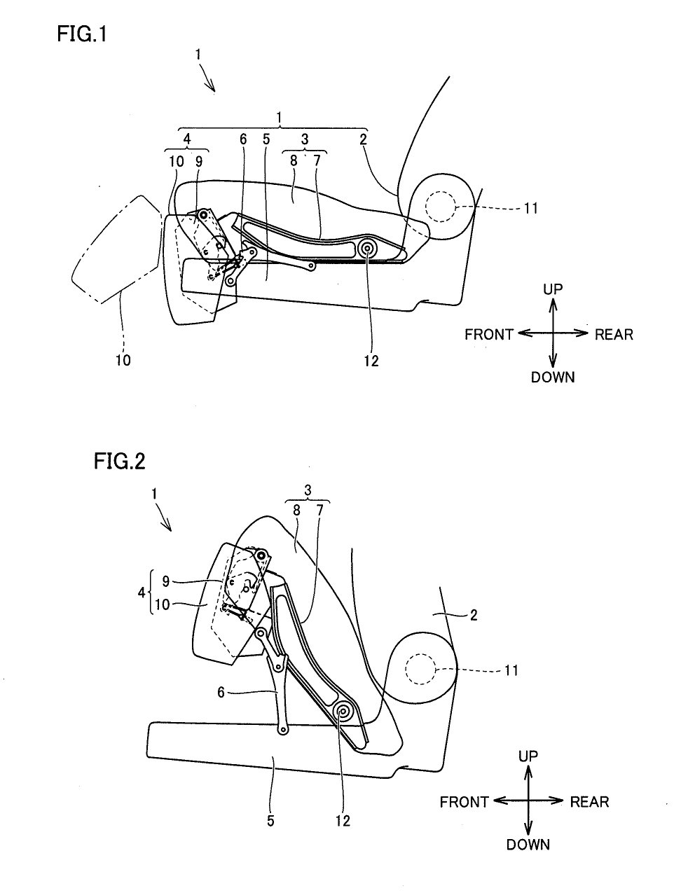

A vehicle seat according to the present first and second embodiments will be described with reference to FIGS. 1 to 14. The same or substantially the same features among features shown in FIGS. 1 to 14 have the same reference characters allotted and redundant description may not be provided.

“Right” shown in FIG. 1 and the like represents a direction on the right of an occupant who sits on a vehicle seat 1. “Left” represents a direction on the left of the occupant who sits on vehicle seat 1. Similarly, “up” or “upper” represents an upward direction and “down”, “lower”, or “below” represents a downward direction. “Front” or “forward” represents a forward direction and “rear” represents a rearward direction. A direction of width of the seat means a lateral direction and a direction of front and rear of the seat means a front-rear direction.

### First Embodiment

FIG. 1 is a side view schematically showing vehicle seat 1. Vehicle seat 1 includes a seat back 2, a seat cushion 3, an ottoman 4, a base 5, and an operation link 6.

Base 5 is arranged on an upper surface of a floor panel of a vehicle. A slider is provided on the floor panel and base 5 is provided on the slider. Base 5 is provided as being movable in the front-rear direction of the vehicle by means of the slider.

Seat back 2 is provided on an upper surface of base 5. Seat back 2 includes a back frame and a back pad. The back pad is arranged on a side of an upper surface of the back frame. Seat back 2 functions as a backrest for an occupant. Seat back 2 is provided on base 5 as being pivotable around a recliner 11 provided on a side of a lower end portion of the back frame.

Seat cushion 3 includes a cushion frame 7 and a cushion pad 8. Cushion pad 8 is arranged on a side of an upper surface of cushion frame 7. Seat cushion 3 functions as a seat portion for an occupant. Cushion frame 7 is provided as being pivotable around a shaft 12 with respect to base 5. Shaft 12 is provided on a side of a rear end of cushion frame 7.

Ottoman 4 is provided in front of seat cushion 3 and specifically provided on a side of a front end portion of cushion frame 7. Ottoman 4 includes a fixed portion 9, an ottoman main body 10, and a link mechanism and a locking mechanism which are not shown. Fixed portion 9 is fixed to a tip end portion of cushion frame 7.

Ottoman main body 10 is a member which supports calves of an occupant. Ottoman main body 10 is provided as being movable with respect to fixed portion 9 and provided to be movable between a storage position and a developed position. The storage position where ottoman main body 10 is stored is located below seat cushion 3. The developed position where ottoman main body 10 is developed is located on a front side of seat cushion 3 and shown with a chain double dotted line in FIG. 1.

The link mechanism is a mechanism which moves ottoman main body 10 between the storage position and the developed position. The locking mechanism is a mechanism which fixes ottoman main body 10 to fixed portion 9 or cancels the fixed state of ottoman main body 10.

Operation link 6 is provided to connect base 5 and fixed portion 9 to each other. Vehicle seat 1 according to the present embodiment includes a tip-up mechanism and an operation portion. When the operation portion is operated, the tip-up mechanism moves seat cushion 3 located at a position for use as a seat as shown in FIG. 1 to a tipped-up position as shown in FIG. 2 and tilts seat back 2 forward.

FIG. 2 is a side view showing vehicle seat 1 while seat cushion 3 is located at a tipped-up position.

Operation link 6 moves ottoman 4 toward a lower surface of seat cushion 3 in a process of movement of seat cushion 3 from the position for use as a seat to the tipped-up position. Vehicle seat 1 can be compact by moving ottoman 4 toward the lower surface of seat cushion 3 when seat cushion 3 is moved to the tipped-up position.

A large space can be created in a rear portion of a compartment by moving vehicle seat 1 forward while seat back 2 is tilted forward and seat cushion 3 is moved to the tipped-up position.

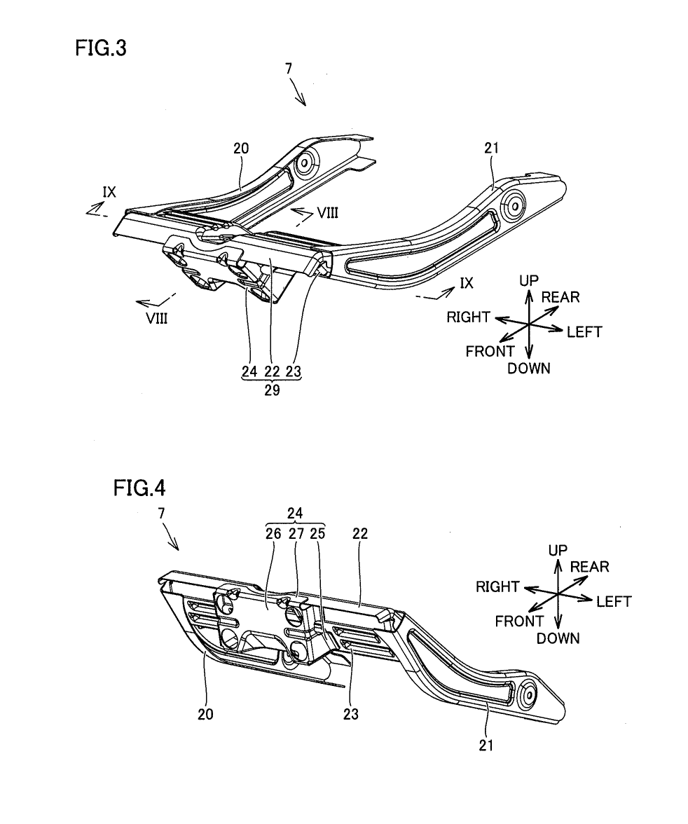

FIGS. 3 and 4 are perspective views showing cushion frame 7. Cushion frame 7 includes a side frame 20, a side frame 21, and an ottoman support portion 29.

Side frames 20 and 21 are formed to longitudinally extend in the front-rear direction of the seat. Side frame 20 and side frame 21 are arranged in the direction of width of the seat at a distance from each other.

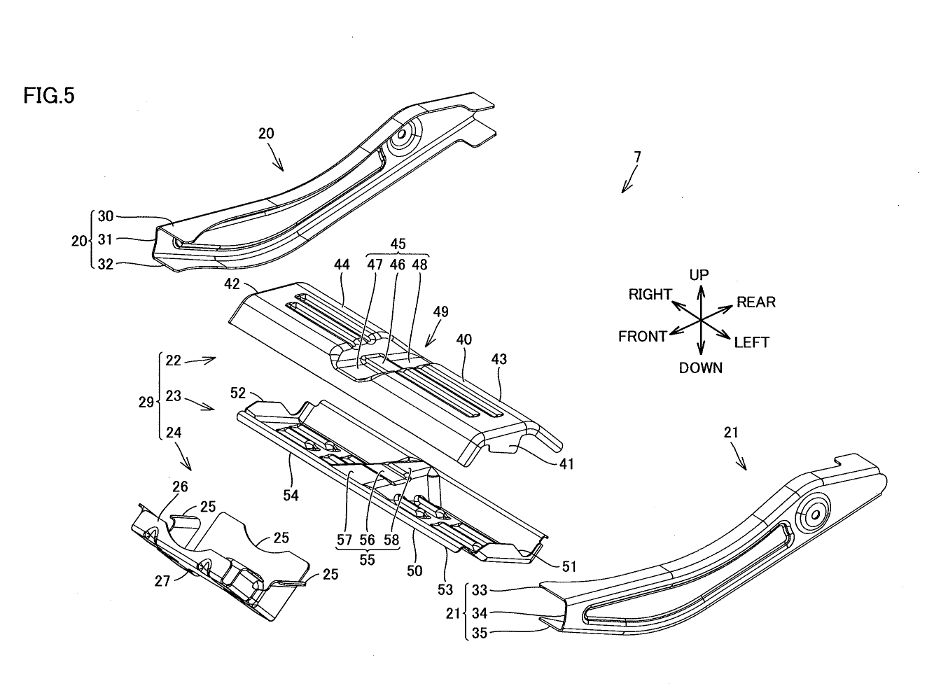

FIG. 5 is an exploded perspective view showing cushion frame 7. Side frame 20 includes an upper wall portion 30, a sidewall portion 31, and a lower wall portion 32. Sidewall portion 31 connects a right side of upper wall portion 30 and a right side of side frame 21 to each other, and side frame 20 is formed to open to the left in the direction of width of the seat.

Side frame 21 includes an upper wall portion 33, a sidewall portion 34, and a lower wall portion 35. Sidewall portion 34 connects a left side of upper wall portion 33 and a left side of lower wall portion 35 to each other. Side frame 21 is formed to open to the right in the direction of width of the seat.

Ottoman support portion 29 includes an upper panel 22, a lower panel 23, and a mount 24.

Upper panel 22 is formed like a plate. Upper panel 22 includes a top plate 40 and side plates 41 and 42.

Top plate 40 is formed to be long in the direction of width of the seat. Top plate 40 includes support plates 43 and 44 and a connection portion 45.

Support plate 43 is provided on a side of side frame 21 and support plate 44 is provided on a side of side frame 20. Support plate 43 and support plate 44 support cushion pad 8 provided on the side of the upper surface of cushion frame 7.

A recess portion 49 is provided between support plate 44 and support plate 43. Recess portion 49 is provided to extend in the front-rear direction of the seat and provided to be recessed toward lower panel 23.

When upper panel 22 provided with recess portion 49 is compared with upper panel 22 without recess portion 49, upper panel 22 provided with recess portion 49 is higher in rigidity.

Connection portion 45 is formed in a bottom portion of recess portion 49. Connection portion 45 includes a front-side connection portion 47, a rear-side connection portion 48, and an intermediate portion 46. Front-side connection portion 47 and rear-side connection portion 48 are formed at a distance from each other in the front-rear direction of the seat. Intermediate portion 46 is formed between front-side connection portion 47 and rear-side connection portion 48.

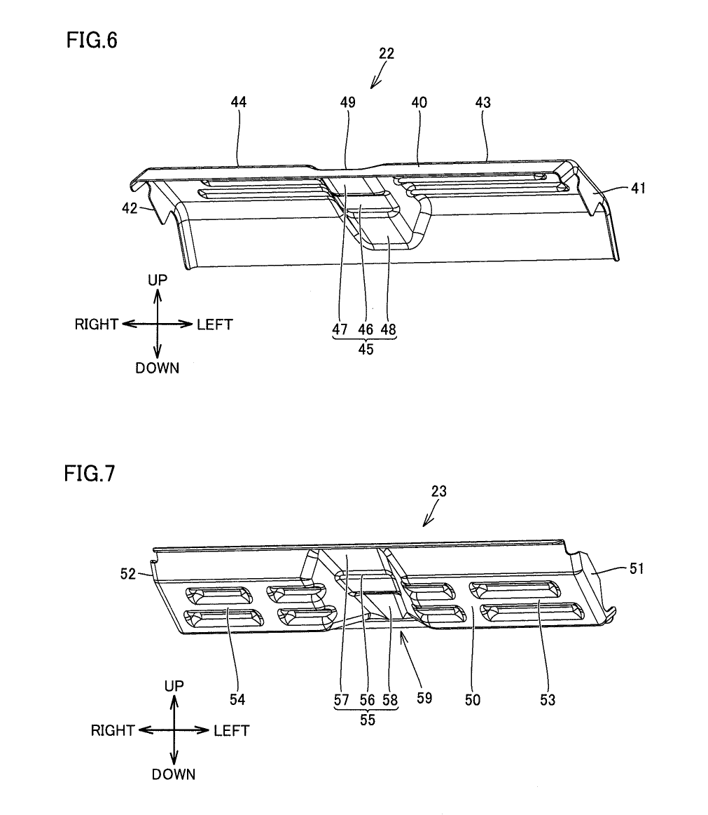

FIG. 6 is a perspective view of upper panel 22 from below. Front-side connection portion 47 and rear-side connection portion 48 are formed to protrude downward and intermediate portion 46 is formed to protrude upward relative to front-side connection portion 47 and rear-side connection portion 48.

When connection portion 45 having intermediate portion 46 formed is compared with connection portion 45 without intermediate portion 46, connection portion 45 having intermediate portion 46 formed is higher in rigidity.

Side plate 42 is formed in the right side of support plate 44 and formed to extend downward from the right side of support plate 44. Side plate 41 is formed in the left side of support plate 43. Side plate 41 is formed to extend downward from the left side of support plate 43.

In FIG. 5, lower panel 23 includes a bottom plate 50 and side plates 51 and 52. Bottom plate 50 includes a support plate 53, a support plate 54, and a connection portion 55, and a recess portion 59 is provided in bottom plate 50. Support plate 53 is provided on the left side in the direction of width of the seat and support plate 54 is provided on the right side in the direction of width of the seat. Mount 24 is attached to support plate 53 and support plate 54.

FIG. 7 is a perspective view of lower panel 23 from below. Recess portion 59 is provided between support plate 53 and support plate 54. Recess portion 59 is provided as being recessed toward upper panel 22 and provided to be recessed upward.

When lower panel 23 provided with recess portion 59 is compared with lower panel 23 without recess portion 59, lower panel 23 provided with recess portion 59 is higher in rigidity.

Connection portion 55 is formed in an upper end wall of recess portion 59. Connection portion 55 includes a front-side connection portion 57, a rear-side connection portion 58, and an intermediate portion 56. Front-side connection portion 57 and rear-side connection portion 58 are formed at a distance from each other in the front-rear direction of the seat. Intermediate portion 56 is formed between front-side connection portion 57 and rear-side connection portion 58.

Intermediate portion 56 is formed to protrude downward from front-side connection portion 57 and rear-side connection portion 58. When connection portion 55 provided with intermediate portion 56 is compared with connection portion 55 without intermediate portion 56, connection portion 55 provided with intermediate portion 56 is higher in rigidity.

Side plate 51 is formed to extend upward from the left side of support plate 53 and side plate 52 is formed to extend upward from the right side of support plate 54. Side plate 52 forms a right end portion (a first end portion) of lower panel 23 and side plate 51 forms a left end portion (a second end portion) of lower panel 23.

In FIGS. 4 and 5, mount 24 includes a fixation plate 27, a welded piece 25, and an engagement piece 26.

Fixed portion 9 of ottoman 4 is fixed to fixation plate 27. Welded piece 25 is welded to lower panel 23. Engagement piece 26 is engaged with and welded to upper panel 22.

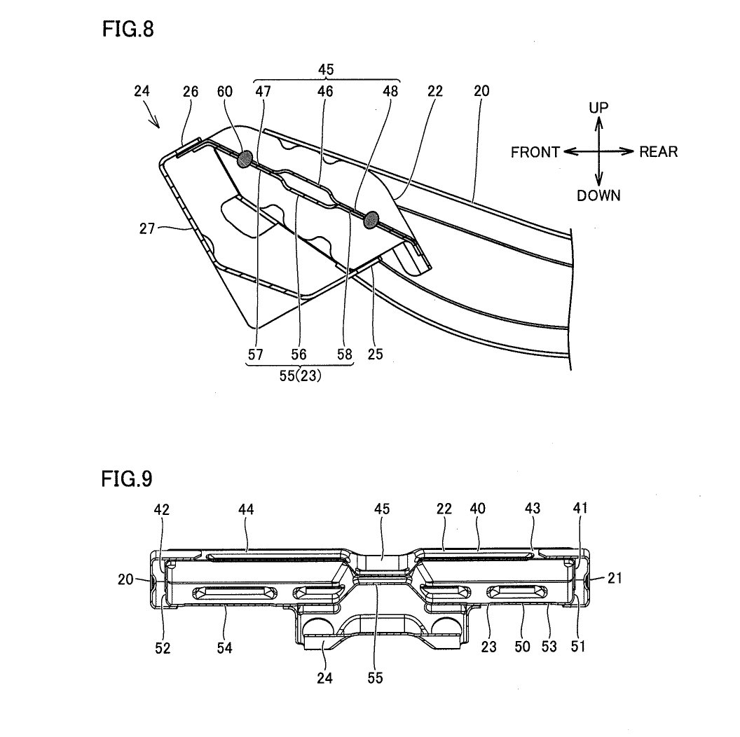

FIG. 8 is a cross-sectional view along the line VIII-VIII shown in FIG. 3. Connection portion 45 of upper panel 22 and connection portion 55 of lower panel 23 are connected to each other by a welding portion 60. Specifically, front-side connection portion 47 and front-side connection portion 57 are welded to each other, and rear-side connection portion 48 and rear-side connection portion 58 are welded to each other. Intermediate portion 46 of connection portion 45 and intermediate portion 56 of connection portion 55 are distant from each other.

FIG. 9 is a cross-sectional view along the line IX-IX shown in FIG. 3. Side frame 21 is arranged on an outer side relatively to side plate 41 of upper panel 22 and side plate 51 of lower panel 23. Similarly, side frame 20 is arranged on an outer side relatively to side plate 42 of upper panel 22 and side plate 52 of lower panel 23.

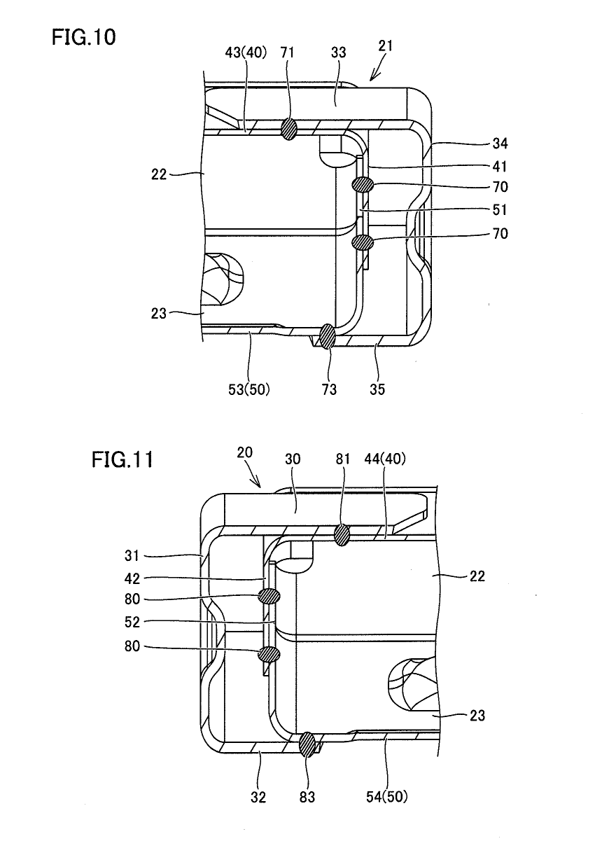

FIG. 10 is a cross-sectional view showing side plate 41 and a feature around the same. Support plate 43 of upper panel 22 is welded to upper wall portion 33 of side frame 21 by a welding portion 71.

Support plate 53 of lower panel 23 is welded to lower wall portion 35 of side frame 21 by a welding portion 73.

Side plate 51 of lower panel 23 is welded to side plate 41 of upper panel 22 by a welding portion 70.

Side frame 21 is provided to cover side plate 41 of upper panel 22 and side plate 51 of lower panel 23 from an outer side.

FIG. 11 is a cross-sectional view showing side plate 42 and a feature around the same.

Support plate 44 of upper panel 22 is connected to upper wall portion 30 of side frame 20 by a welding portion 81. Support plate 54 of lower panel 23 is welded to lower wall portion 32 of side frame 20 by a welding portion 83.

Side plate 52 of lower panel 23 is welded to side plate 42 of upper panel 22 by a welding portion 80.

In vehicle seat 1 constructed as above, a load such as a self weight of ottoman 4 is applied to lower panel 23.

As shown in FIGS. 10 and 11, lower panel 23 is connected to lower wall portions 32 and 35 of side frames 20 and 21 and side plates 42 and 41 of upper panel 22.

Since lower panel 23 is connected to side frames 20 and 21 and upper panel 22 at a plurality of positions, large deflection of lower panel 23 can be suppressed.

Side plates 51 and 52 of lower panel 23 are located at respective opposing ends in a direction of width of lower panel 23 and connected to upper panel 22, and bottom plate 50 of lower panel 23 has respective opposing end portions connected to side frames 20 and 21.

Lower panel 23 has thus opposing end portion sides firmly connected to side frames 20 and 21 or upper panel 22. Therefore, even though a load such as a self weight of ottoman 4 is applied to lower panel 23, deformation of the opposing end portion sides of lower panel 23 can be suppressed. Consequently, an amount of deformation of the entire lower panel 23 can be suppressed.

As shown in FIG. 8, connection portion 45 is located in a central portion in the direction of width of upper panel 22 and connection portion 55 is located in a central portion in the direction of width of lower panel 23. Connection portion 45 of upper panel 22 and connection portion 55 of lower panel 23 are connected to each other by welding portion 60.

Lower panel 23 is connected to upper panel 22 not only at opposing ends in the direction of width of the seat but also in the central portion in the direction of width of the seat.

Upper panel 22, lower panel 23, and side frames 20 and 21 are thus connected at a plurality of locations, so that rigidity of the entire ottoman support portion 29 is improved.

Occurrence of a largely deformed portion also in ottoman support portion 29 as a whole can thus be suppressed.

As shown in FIG. 5, cushion pad 8 is supported by upper panel 22 formed like a plate. As compared with an example in which upper panel 22 is formed like a pipe, an occupant is less likely to feel upper panel 22 and occupant's feeling in sitting is better.

Though side plate 52 which is the right end portion of lower panel 23 is welded to upper panel 22 and side plate 51 which is the left end portion of lower panel 23 is welded to upper panel 22 in the first embodiment, at least one of side plate 52 and side plate 51 may be welded to upper panel 22.

In the first embodiment, side frames 20 and 21 are arranged on the outer side of upper panel 22 and lower panel 23 and provided such that upper panel 22 and lower panel 23 lie therebetween.

Various arrangements, however, can be adopted for side frames 20 and 21, upper panel 22, and lower panel 23.

### Second Embodiment

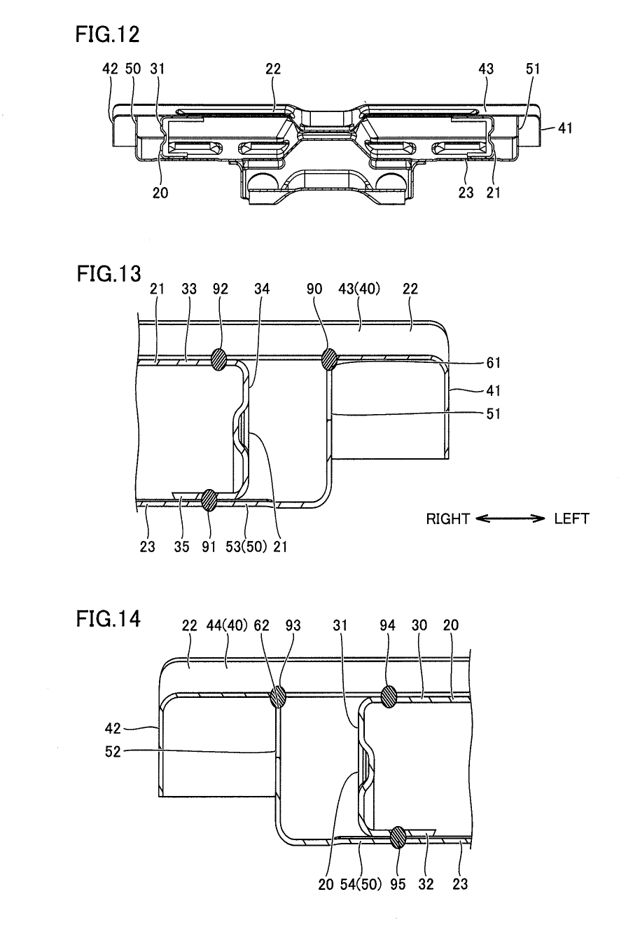

FIG. 12 is a cross-sectional view showing upper panel 22, lower panel 23, and side frames 20 and 21 in the vehicle seat according to a second embodiment.

Side frame 20 and side frame 21 are arranged between upper panel 22 and lower panel 23.

Upper panel 22 is longer in length in the direction of width of the seat than side frame 20 and side frame 21. Side plate 41 of upper panel 22 is located at a position more distant toward the left in the direction of width of the seat than side frame 21. Side plate 42 of upper panel 22 is located at a position more distant toward the right in the direction of width of the seat than side frame 20.

Lower panel 23 is longer in length in the direction of width of the seat than side frame 20 and side frame 21. Side plate 51 of lower panel 23 is arranged between sidewall portion 34 of side frame 21 and side plate 41 of upper panel 22. Side plate 52 of lower panel 23 is arranged between sidewall portion 31 of side frame 21 and side plate 42 of upper panel 22.

Upper panel 22 is longer in length in the direction of width of the seat than lower panel 23. Since upper panel 22 is longer in length in the direction of width of the seat, a cushion pad long in length in the direction of width of the seat can be arranged on the upper surface of upper panel 22 so that comfort in sitting is improved.

FIG. 13 is a cross-sectional view showing side plate 51 of lower panel 23 and a feature around the same. Lower panel 23 includes an end portion 61 located on the left in the direction of width of the seat and end portion 61 is located at an upper end portion of side plate 51. End portion 61 is formed to longitudinally extend in the front-rear direction of the seat.

End portion 61 of lower panel 23 is connected to a lower surface of support plate 43 of upper panel 22 by a welding portion 90. Support plate 53 of lower panel 23 is connected to lower wall portion 35 of side frame 21 by a welding portion 91.

Upper wall portion 33 of side frame 21 is connected to support plate 43 of upper panel 22 by a welding portion 92. FIG. 14 is a cross-sectional view showing side plate 52 of lower panel 23 and a feature around the same. Lower panel 23 includes an end portion 62 located on the right in the direction of width of the seat and end portion 62 is located at an upper end portion of side plate 52. End portion 62 is formed to longitudinally extend in the front-rear direction of the seat.

End portion 62 of lower panel 23 is connected to a lower surface of support plate 44 of upper panel 22 by a welding portion 93. Support plate 54 of lower panel 23 is connected to lower wall portion 32 of side frame 20 by a welding portion 95.

Upper wall portion 30 of side frame 20 is connected to support plate 44 of upper panel 22 by a welding portion 94.

In the vehicle seat constructed as above, when a load such as a self weight of ottoman 4 is applied to lower panel 23, the load is applied to upper panel 22 with side plates 51 and 52 of lower panel 23 being interposed. This load is applied in the downward direction.

The load applied to upper panel 22 is born by side frames 20 and 21. Since side frames 20 and 21 are located below upper panel 22, upper panel 22 is pressed against side frames 20 and 21.

Consequently, application of a load to welding portion 92 in a direction to move upper panel 22 and side frame 21 away from each other in the vertical direction can be suppressed and break of welding portion 92 can be suppressed.

In the vehicle seat according to the present second embodiment as well, lower panel 23 has support plates 53 and 54 connected to respective side frames 21 and 20 and side plates 51 and 52 connected to upper panel 22. Therefore, large deformation of lower panel 23 is suppressed.

Though both of end portion 61 and end portion 62 of lower panel 23 are welded to upper panel 22 in the second embodiment, at least one of end portion 61 and end portion 62 may be welded to upper panel 22.

The present disclosure is summarized as follows.

A vehicle seat according to the present disclosure includes a seat cushion on which an occupant sits and an ottoman provided on the seat cushion. The seat cushion includes a first side frame and a second side frame provided at a distance from each other in a direction of width of a seat and an ottoman support portion provided in the first side frame and the second side frame. The ottoman support portion includes an upper member, a lower member arranged below the upper member, and a mount connected to the lower member. The upper member is connected to the first side frame and the second side frame. The lower member is connected to the first side frame and the second side frame. The lower member includes a first end portion and a second end portion located in the direction of width of the seat and at least one of the first end portion and the second end portion is connected to the upper member.

According to the construction above, the lower member is supported by the first and second side frames and the upper member. Therefore, deformation of the lower member is suppressed.

The first side frame and the second side frame are arranged between the upper member and the lower member. The lower member includes a first end portion located on one side in the direction of width of the seat and a second end portion located on the other side. At least one of the first end portion and the second end portion is connected to a lower surface of the upper member.

According to the construction above, a load such as a self weight of the ottoman is applied to the lower member and the lower member is pulled downward by the load. The load applied to the lower member is applied also to the upper member and the upper member is also pulled downward. The first side frame and the second side frame are arranged between the upper member and the lower member. Therefore, the load is applied to the first and second side frames and the upper member in a direction toward each other. Therefore, such deformation that the first and second side frames and the upper member move away from each other can be suppressed.

The upper member is longer in length in the direction of width of the seat than the lower member. According to the construction above, a cushion pad long in the direction of width of the seat can be arranged on an upper surface of the upper member and occupant's comfort in sitting can be improved.

The upper member is implemented by an upper panel in a form of a plate. According to the construction, the cushion pad is supported by the upper panel formed like a plate. When the upper member is formed from a member in a form of a pipe, an occupant tends to feel the upper member. By forming the upper member like a plate, the occupant is less likely to feel the upper member and comfort in sitting can be improved.

Though embodiments of the present disclosure have been described, it should be understood that the embodiments disclosed herein are illustrative and non-restrictive in every respect. The scope of the present invention is defined by the terms of the claims and is intended to include any modifications within the scope and meaning equivalent to the terms of the claims.

What is claimed is:

1. A vehicle seat comprising:
a seat cushion which supports an occupant; and
an ottoman provided on the seat cushion,
the seat cushion including
a first side frame and a second side frame provided at a distance from each other in a direction of width of the seat, and
an ottoman support portion provided in the first side frame and the second side frame,
the ottoman support portion including
an upper member,
a lower member arranged below the upper member, and
a mount connected to the lower member,
the upper member being connected to the first side frame and the second side frame,
the lower member being connected to the first side frame and the second side frame,
the lower member including a first end portion and a second end portion located in the direction of width of the seat, and
at least one of the first end portion and the second end portion being connected to the upper member.

2. The vehicle seat according to claim 1, wherein
the first side frame and the second side frame are arranged between the upper member and the lower member, and
at least one of the first end portion and the second end portion is connected to a lower surface of the upper member.

3. The vehicle seat according to claim 2, wherein
the upper member is longer in length in the direction of width of the seat than the lower member.

4. The vehicle seat according to claim 1, wherein
the upper member is implemented by an upper panel in a form of a plate.
